(19) United States
(12) Patent Application Publication
(10) Pub. No.: US 2006/0106983 A1
(43) Pub. Date: May 18, 2006

(54) Personal information exchange

(76) Inventors: James Thomas Edward McDonnell, Bristol (GB); David Neil Slatter, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,691

(22) Filed: Oct. 26, 2005

(30) Foreign Application Priority Data
Oct. 29, 2004 (GB) 0424133.7

(51) Int. Cl. G06F 12/00

(52) U.S. Cl. 711/115

(57) ABSTRACT

A method of updating a memory of a device with data stored in a memory of a tag, the tag associated with a business or calling card, the method comprising writing data read from the tag memory to the device memory, and writing data to the tag memory.

### FIELD OF THE INVENTION

The present invention relates to the field of exchanging personal information.

### BACKGROUND

It is known to provide scanners and optical character recognition (OCR) software for use in scanning business cards and transferring the data thereon to a PDA, computer or similar. It is also known that data for a personal information manager (PIM) can be printed onto business cards so that it can be scanned and loaded into a card recipients PIM device or software program.

The use of such systems is inflexible and has obvious drawbacks including the necessity to carry a scanner around, or wait until a more convenient time to scan a business card. Furthermore the success rate of OCR software in converting written text to an electronic format is not perfect resulting in data loss or corruption, and inconvenience.

### SUMMARY OF THE PRESENT INVENTION

According to a first aspect of the present invention there is provided a method of updating a memory of a device with data stored in a memory of a tag, the tag associated with a business or calling card, the method comprising writing data read from the tag memory to the device memory, and writing data to the tag memory.

According to a second aspect of the present invention there is provided a method of using contact information data stored in a memory of a tag, the tag associated with a business or calling card, the method comprising uploading the contact information data into a device memory, and writing annotation data to the memory of the tag using the device.

According to a third aspect of the present invention there is provided a computer program product for use with a device, said computer program product comprising a device useable medium having device executable program code stored thereon, wherein the product is operable, in association with the device, to update a memory of the device with data stored in a memory of a tag, the tag associated with a business or calling card, by causing data to be read from the tag memory and written to the device memory, and data to be written to the tag memory.

According to a fourth aspect of the present invention there is provided a computer program, comprising machine readable instructions, wherein said program is arranged, in association with said machine, to update a memory of the machine with data stored in a memory of a tag, the tag associated with a business or calling card, by causing contact information data to be uploaded into the machine memory, and causing annotation data to be written to the memory of the tag using the machine.

According to a fifth aspect of the present invention there is provided a computer program product comprising a computer readable medium having thereon computer program instructions, such that, when said program is loaded in a memory of the computer, the instructions cause the computer to update a memory of a device with data stored in a memory of a tag, the tag associated with a business or calling card, by uploading contact information data into the device memory, and writing annotation data to the memory of the tag using the device.

According to a sixth aspect of the present invention there is provided a device suitable for use in any preceding claim, the device comprising a memory operable to store data received from a memory tag, and read/write circuitry for reading/writing data respectively from/to a memory tag.

### BRIEF DESCRIPTION OF THE FIGURES

For a better understanding of the present invention, and to further highlight the ways in which it may be brought into effect, various embodiments will now be described, by way of example only, with reference to the following drawings in which:

FIG. 1 is a schematic representation of a memory tag suitable for use in accordance with a preferred embodiment;

FIG. 2 is a schematic representation of the circuitry of a memory tag of FIG. 1 and exemplary read/write circuitry;

FIG. 3 is a schematic representation of an exemplary card comprising a tag of FIG. 1;

FIG. 4 is a schematic representation of a device suitable for reading data from a card comprising a tag;

FIG. 5 is a flow diagram representing steps taken by a card owner in updating data of the memory tag; and

FIG. 6 is a flow diagram representing a preferred use model of the card of FIG. 3.

It should be emphasized that the term “comprises/comprising” when used in this specification specifies the presence of stated features, integers, steps or components but does not preclude the presence or addition of one or more other features, integers, steps, components or groups thereof.

### DETAILED DESCRIPTION

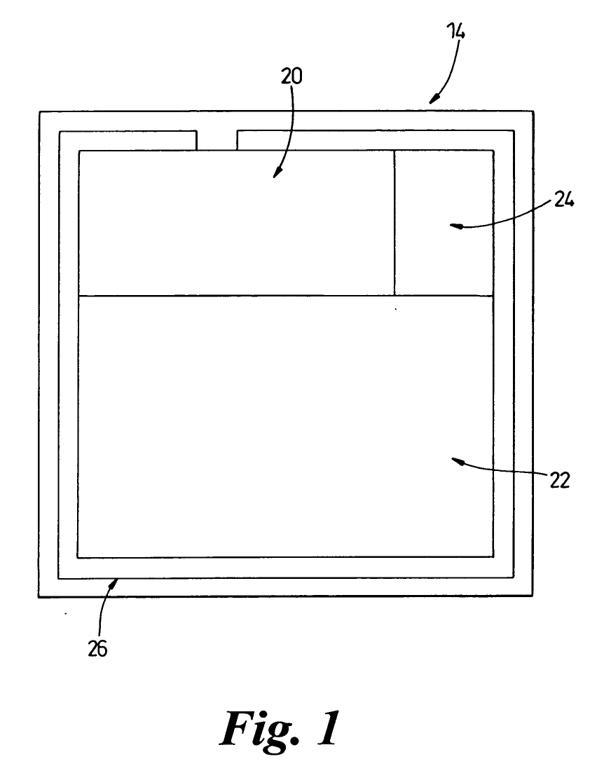

FIG. 1 of the accompanying drawings is a schematic representation of a memory tag suitable for use in accordance with a preferred embodiment. The tag 14 is provided on a chip, and comprises a circuit 20, a memory 22, a power supply capacitor 24, and an antenna coil 26 having only a few turns, e.g. five, or in this case in the figure, a single turn. In a preferred embodiment, the circuit 20 operates at a frequency of 2.45 GHz, and is of an area approximately 0.5 mm², and uses FRAM (ferroelectric random access memory) or MRAM (magnetoresistive random access memory) or similar memory technology characterised by low power requirements for example. The memory tag 14 is of substantially square shape in plan view with an external dimension D for its sides of around 1 mm. It will appreciated by those skilled in the art that other configurations for tag 14 are possible which have the same functionality, but which can differ in shape and dimensions for example.

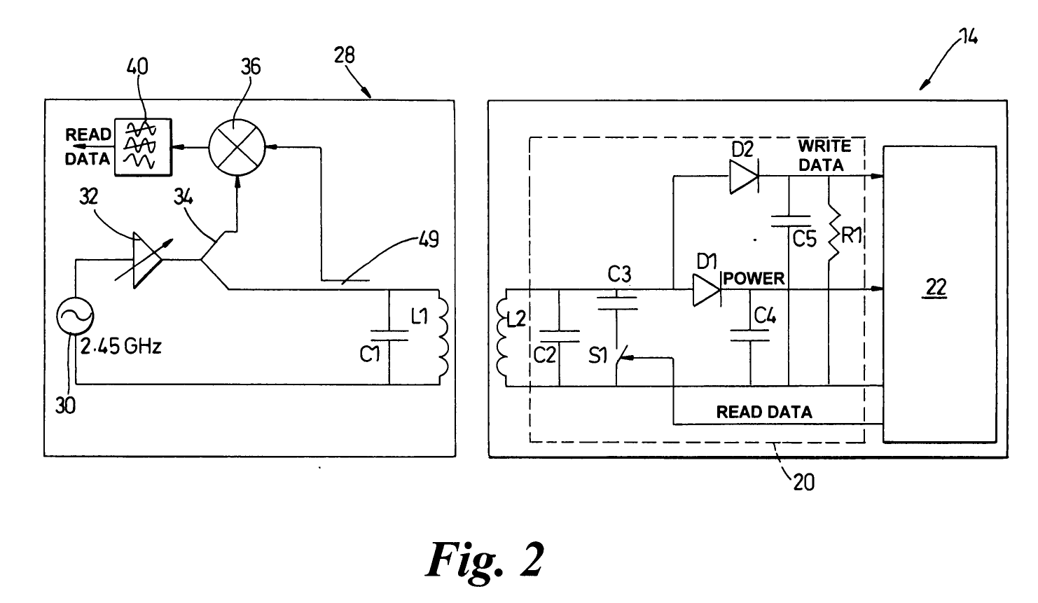

In FIG. 2, the circuitry of a memory tag 14 and exemplary read/write circuitry 28 of a device (not shown) are illustrated schematically, using conventional component identifications (C-capacitor, L-inductance, R-resistor, D-diode and S-switch). In an embodiment, circuit 20 of the memory tag 14 comprises a capacitor C2 which, in combination with the antenna coil L2, forms a resonant circuit with component values being chosen to tune the combination to approximately 2.45 GHz for inductive coupling with a read/write device. The portion of circuit 20 responsible for power supply is diode D1 and capacitor C4, with diode D1 rectifying the alternating current generated by the inductive coupling and the capacitor C4 acting as a power supply storage. The portion of circuit 20 responsible for receiving transmitted data from a read/write device is diode D2, capacitor C5 and resistor R1 which form an envelope detector; data thus received is stored in memory 22. The portion of circuit 20 responsible for the reading of data from the memory 22 is the tuned circuit L2/C2 in combination with S1 and C3, switching C3 in and out of the circuit using S1 changes the resonance of tuned circuit L2/C2 resulting in phase modulation of the reflected power from the memory tag 14 to a read/write device.

Circuit 28 is operable to effect reading and writing of data to and from the memory tag 14. Read/Write circuit 28 comprises a signal generator 30 which generates a signal at the chosen frequency of 2.45 GHz. For transmitting data to the tag 14, this signal passes via an amplitude modulator 32, where it is amplitude modulated with data to be written to the memory tag 14, and a splitter 34, to an antenna L1 and capacitor C1 which form a tuned circuit. The component values of L1 and C1 being chosen to tune it to 2.45 GHz, as for the tuned circuit in the memory tag 14, in order to maximise inductive coupling between the two circuits, and thus transmission of power and data to and from the memory tag 14.

Although memory tag 14 is described above as operating at 2.45 GHz it should be understood that a tag operating at other frequencies can be implemented and used. Factors affecting the choice of operating frequency for a tag include: a) government regulations concerning radio frequency transmissions; b) adequate bandwidth (consistent with government regulations); c) frequency high enough to render the physical size of components in the memory tag small enough to keep the area of silicon required low (and hence the cost to manufacture low); d) frequency low enough to provide adequate performance when using low-cost high-volume CMOS technology to manufacture the memory tag.

A tag of this functional type can be produced using RF technology, as described above. Alternatively, optical technologies can be used to power, read and write to a memory tag, as described in the Applicant's earlier British Patent Application No. 0227152.6 for example.

The terms ‘memory tag’ and ‘tag’ are used interchangeably, and are not intended to be limiting. Such terms refer to a device substantially as herein described with reference to FIG. 1 for example, which is a device comprising a memory from which data can be read, and to which data can be written, using an inductive coupling of the device with a read/write device for example, or using other means such as optical technology as described above.

According to a preferred embodiment, tag 14 is embedded in, mounted on, or otherwise attached to a business (or calling) card, or similar, and memory 22 is operable to store data relating to the owner of the card such as personal and/or business contact details, including, but not limited to any one or more of names, addresses, telephone numbers, fax numbers, email addresses, photographs and the like. The owner can be a person, or an entity such as a corporate entity for example. Memory 22 can programmed with the necessary data at the time the business card is made, and/or the data can be programmed or amended at a later data using a suitable device comprising read/write circuitry such as 28.

Circuitry 28 can be integrated into a mobile station such as a mobile telephone or similar, or a PDA, or other similar mobile communications device or machine. Details of the card owner stored in memory 22 of a tag 14 can be read by such a device and stored in a memory thereof for future reference and use. Circuitry 28 can be used to write data to tag 14 whilst it is attached to the card.

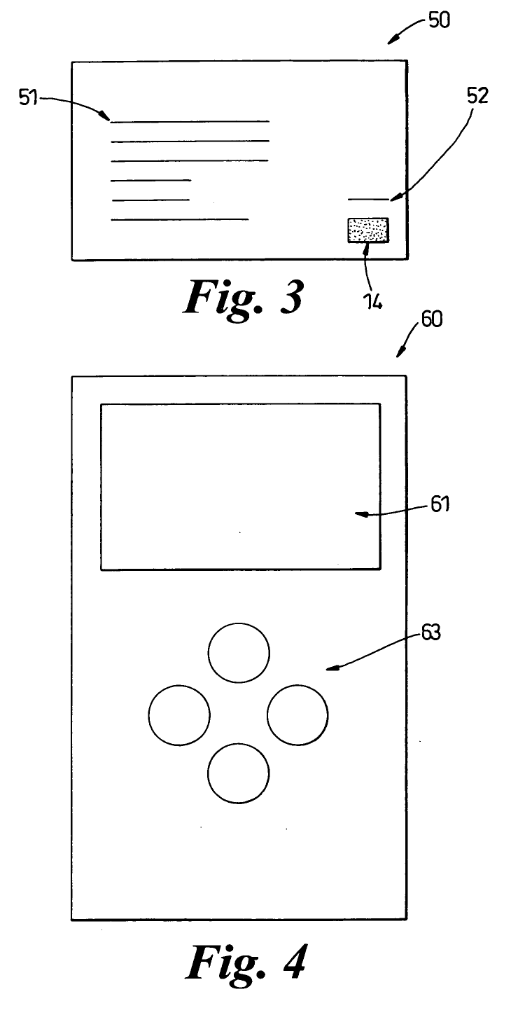

FIG. 3 of the accompanying drawings is a schematic representation of an exemplary card (not to scale) according to an embodiment.

The card 50 can comprise conventional written details 51 of the card owner. Card 50 comprises a memory tag 14. Tag 14 is embedded in the card 50, and its position in the card can be indicated by indicia 52 on the card 50 such as a suitable printed, raised or embossed area of the card or similar. Other methods of attaching the tag to the card 50 are possible. For example, tag 14 can be attached to card 50 using a suitable adhesive or other means of fixing such as laminating tag 14 onto card 50. It will be appreciated that the above are not intending to be limiting, and that the advantageous provision of a card comprising a memory tag is not dependent on the method used to mount, embed or otherwise dispose the tag 14 to or on card 50.

Preferably, card 50 has a specific form factor. For example, a card can be the same size and shape as conventional business cards (generally rectangular in shape, and formed from cardboard or similar material). In this way the cost of production of card 50 can be kept to a minimum.

In a preferred embodiment the card 50 is a business card. Such a card can comprise a portion of a user's profile for example. Other characterizations are possible, and the provision of a memory tag embedded in or mounted on a card is not intended to be limited to business cards.

Indicia 52 can provide an aid to determining the location of tag 14 when reading data from memory 22 using a suitable device such as that mentioned above. Indicia 52 can also provide an indication that a card comprises a tag in order to allow it to be distinguished from cards that do not for example. Indicia 52 can further provide details as to the content of a memory of a tag, for example.

FIG. 4 is a schematic representation of a device 60 suitable for at least reading data from a memory 22 of tag 14. The device can include a display 61 for presenting information to a user, and buttons/touch pads (or device menu options) 63 for allowing a user to select device functions. The device 60 can include additional functionality enabling it to write data to memory 22 as appropriate. For example, device 60 can include read/write circuitry 28, or alternatively, can comprise only read or write circuitry as appropriate.

According to a preferred use model, data relating to an owner of a card 50 which can be a business card or calling card or similar can be read by device 60. The device can be used by a recipient of the card 50. If writing data to memory 22 of the tag is permitted, device 60 can allow a recipient to write data to the card as will be explained in further detail below. Device 60 can include an address book or contact list or similar in which data from memory 22 can be stored in a suitable format for retrieval by a user. The address book/contact list of device 60 can therefore be updated according to data stored in tag 14. For example, device 60, when in a suitable read-mode of operation—the mode selectable by a user of the device, or automatically by device 60 as appropriate—can store data read from memory 22 of a tag 14 embedded in a card 50, and use the data to update any details of the owner of the card 50 it has stored. If, for example, no details exist in a memory of device 60, it can generate a new data record in a device memory (not shown) for storing the relevant tag data. Device 60 can be a PIM device (or software on device 60 can be PIM software), in which case data read from the card 50 can be used to update or write to relevant fields of the PIM. Data stored in memory 22 of tag 14 can therefore be stored in a format suitable for use with a PIM.

As mentioned, the data stored on card 50 can comprise a phone number, or set thereof, an email address, or set thereof, the name of the card owner and so forth. Hence, data read from tag 14 can be used to update or generate records in device 60 for subsequent use. In the case that a plurality of data records exist in memory 22 for a particular data field, such as two or more phone numbers for example, device 60 can prompt a user to select which data record to store, or can automatically store all or some of the data based on user preference, or automatically, or optionally using a learned function of device 60 based on user preference.

So, for example, if a card 50 incorporating a tag 14 comprising memory 22, which memory has data stored thereon representative of a card owner's business and personal telephone numbers, device 60, when in a suitable mode of operation, and when within range of card 50, is operable to read data stored in memory 22, and commit the data to a device 60 memory. The user can be prompted by device 60, using a suitable display of device 60 for example, which of the phone numbers should be stored. Alternatively, as mentioned, device 60 can store all data by default. A device memory is updated accordingly with the data. A suitable memory of device 60 can be dynamic random-access memory (DRAM) and can include either non-volatile memory (e.g. flash, ROM, PROM, etc.) and/or removable memory (e.g. memory cards, disks, etc.).

With appropriate write functionality in device 60, such as circuitry 28, the device can write data to memory 22 of tag 14. Data written to tag 14 by the card recipient can comprise a history of interaction of device 60 with tag 14 for example. Such data can represent the number of times memory 22 of a tag 14 has been queried by device 60, and the amount and/or type of data downloaded from or uploaded to memory 22 for example. Other alternatives are possible. For example, a user of device 60 can input data to device 60 which can be transferred to memory 22 of tag 14. Such data transferred to tag 14 can comprise a text message or annotation, voice message, contact details or other data such as an interaction history for example, or metadata relating to when and where card 50 was distributed for example. The data transferred back to the card by the recipient can be context data relating to the meeting in which the card was received for example.

Transferred data is stored in memory 22 and can be read by suitable read circuitry such as that of circuit 28 for example. For example, if a card owner gives someone card 50, that person can use device 60 to upload data stored in memory 22 of tag 14 of the card 50 to a device 60 memory, and additionally can modify data in or add data to memory 22 of tag 14 using write circuitry of device 60.

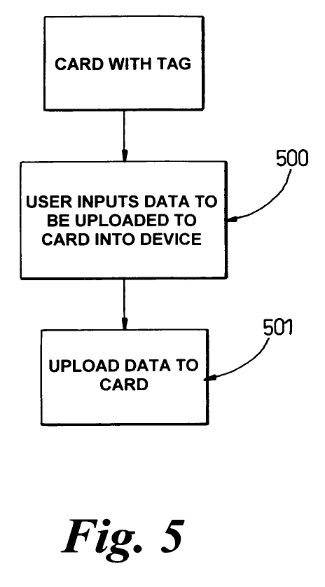

FIG. 5 is a flow diagram representing steps taken in updating data of the memory tag associated with the card. Data to be uploaded to a card is input into a suitable device at step 500. The data can be annotation data representative of a context of a meeting (or other event) in which the card was received. Alternatively, the data can be contact information data. The data can be a voice recording for example, or metadata. Other alternatives are possible. The device used can be a mobile telecommunications device such as a mobile telephone which includes the necessary functionality to write data to a memory of the tag associated with the card to be updated, or a device such as 60. Alternatively, data to be uploaded can be input to a computer or similar for transfer to the card directly, or via the device. At 501, data to be uploaded is transferred to a memory of the tag associated with the card to be updated. Data to be uploaded can be input to the write device (or computer etc) in a format suitable for use with a PIM application.

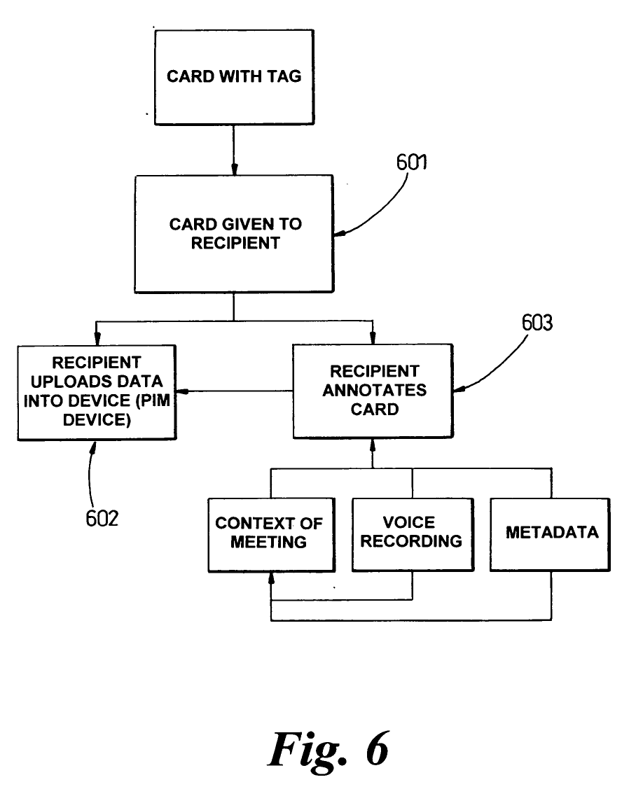

FIG. 6 a flow diagram representing a preferred use model associated with issue of the card of FIG. 3. At step 601, the card is given to a recipient. At 602, the recipient uploads data stored on the memory of the tag associated with the received card into a suitable device such as that described above. Before, or after relevant data has been uploaded by the recipient, data can be transferred to the card by the recipient at step 603. For example, the recipient can upload data relating to a context of the meeting in which the card was received. Such data can include a voice recording or metadata for example.

The data can be used in a PIM of the recipient. For example, each relevant piece of data uploaded from the card by the recipient into a device can be stored in a suitable field such as ‘name’, ‘address’ etc. Other alternatives are possible as will be appreciated.

1. A method of updating a memory of a device with data stored in a memory of a tag, the tag associated with a business or calling card, the method comprising:
writing data read from the tag memory to the device memory; and
writing data to the tag memory.

2. A method as claimed in claim 1, wherein the tag is mounted on, embedded in or otherwise attached to the business or calling card.

3. A method as claimed in claim 1 further comprising providing indicia on a portion of the card indicating the presence, or position and/or type of tag on the card.

4. A method as claimed in any of claim 1, wherein writing data to the tag memory comprises updating the tag memory with data relating to a history of interaction of the card and the device.

5. A method as claimed in claim 4, wherein the data relating to a history of interaction of the card and the device is metadata representing at least a time and date when the card was distributed or received.

6. A method as claimed in claim 1, wherein data written to the tag memory comprises note or context data associated with the card.

7. A method as claimed in claim 1, wherein data written to the tag memory comprises an annotation by a card provider or receiver relating to a distribution or receipt of the card respectively.

8. A method as claimed in claim 7, wherein the annotation comprises data representing a voice recording.

9. A method as claimed in claim 6, wherein data written to the tag memory comprises metadata relating to distribution or receipt of the card.

10. A method as claimed in claim 1, wherein data written to the tag comprises data representing a context in which the card has been distributed or received.

11. A method as claimed in claim 1, wherein data stored in the tag memory is contact information data in a format suitable for use with a personal information manager.

12. A method as claimed in claim 1, wherein data written to the tag memory is in a format suitable for use with a personal information manager.

13. A method of using contact information data stored in a memory of a tag, the tag associated with a business or calling card, the method comprising:
uploading the contact information data into a device memory; and
writing annotation data to the memory of the tag using the device.

14. A method as claimed in claim 13, wherein the annotation data relates to a context of a meeting in which the card was received.

15. A method as claimed in claim 13, wherein the annotation data represents a voice recording.

16. A method as claimed in claim 13, wherein the annotation data is metadata representing the context of a meeting in which the card was received.

17. A business card comprising a tag, the tag comprising a memory storing data relating to a possessor of the card, the data modifiable by a suitable remote device.

18. A business card as claimed in claim 17, wherein the data is in a format suitable for use with a personal information manager.

19. A computer program product for use with a device, said computer program product comprising:
a device useable medium having device executable program code stored thereon, wherein the product is operable, in association with the device, to update a memory of the device with data stored in a memory of a tag, the tag associated with a business or calling card, by causing data to be read from the tag memory and written to the device memory; and
data to be written to the tag memory.

20. A computer program, comprising machine readable instructions, wherein said program is arranged, in association with said machine, to update a memory of the machine with data stored in a memory of a tag, the tag associated with a business or calling card, by causing contact information data to be uploaded into the machine memory; and
causing annotation data to be written to the memory of the tag using the machine.

21. A computer program product comprising a computer readable medium having thereon computer program instructions, such that, when said program is loaded in a memory of the computer, the instructions cause the computer to update a memory of a device with data stored in a memory of a tag, the tag associated with a business or calling card, by:
uploading contact information data into the device memory; and
writing annotation data to the memory of the tag using the device.

22. A program stored on computer-readable medium, the program comprising instructions configured to cause a computer to update a memory of a device in accordance with the method claimed in claim 1.

23. A logic circuit configured to operate in accordance with the method claimed in claim 1.

24. A device suitable for use in claim 1, the device comprising:
a memory operable to store data received from a memory tag; and
read/write circuitry for reading/writing data respectively from/to a memory tag.

25. A device as claimed in claim 24, further comprising a PIM tool operable to use data read from the tag.

26. A program stored on computer-readable medium, the program comprising instructions configured to cause a computer to update a memory of a device in accordance with the method claimed in claim 13.

27. A logic circuit configured to operate in accordance with the method claimed in claim 13.

28. A device suitable for use in claim 13, the device comprising:
a memory operable to store data received from a memory tag; and
read/write circuitry for reading/writing data respectively from/to a memory tag.
